(19) United States
(12) Patent Application Publication
(10) Pub. No.: US 2019/0220898 A1
(43) Pub. Date: Jul. 18, 2019

(54) SYNCHRONIZATION SYSTEM FOR ROADSIDE ADVERTISING AND VEHICLES

(71) Applicant: FORD GLOBAL TECHNOLOGIES, LLC, Dearborn, MI (US)

(72) Inventors: Kevin James RHODES, Dearborn, MI (US); Chad BEDNAR, Royal Oak, MI (US); Pallav SOHONI, Farmington Hills, MI (US); Erik J. CHRISTEN, Royal Oak, MI (US)

(21) Appl. No.: 15/871,778

(22) Filed: Jan. 15, 2018

(51) Int. Cl. G06Q 30/02

(52) U.S. Cl. CPC G06Q 30/0266; G06Q 30/0256; G06F 7/026; G06Q 30/0267; G06Q 30/0254

(57) ABSTRACT

A roadside advertising system includes a roadside display. The system further includes a controller programmed to receive preference and vehicle data associated with one or more vehicles within a predetermined distance of the roadside display and to cause display of an advertisement corresponding to one of a plurality of preferences from the vehicles that maximizes a weighted preference function derived from vehicles within a maximum viewing distance of the roadside display.

### TECHNICAL FIELD

This application generally relates to a system for synchronizing roadside advertising messages to preferences associated with vehicles within a predetermined distance.

### BACKGROUND

Roadside advertising is present along many roadways. Traditional roadside advertising includes billboards with fixed content that is periodically changed manually. More modern roadside advertising includes large displays that can change the display content dynamically. A typical display system may cycle through a predetermined rotation of stored advertisements. However, these systems do not dynamically target drivers that are viewing the advertisements.

### SUMMARY

A roadside advertising system includes a roadside display. The roadside advertising system further includes a controller programmed to receive preference and vehicle data associated with one or more vehicles within a predetermined distance of the roadside display and to cause display of an advertisement corresponding to one of a plurality of preferences from the vehicles that maximizes a weighted preference function derived from vehicles within a maximum viewing distance of the roadside display.

The weighted preference function may be derived from a viewing time for each of the vehicles that is a ratio of a distance of a corresponding vehicle to the display to a speed of the corresponding vehicle. The preference and vehicle data may include at least some of the preferences, a position, and a speed for each of the vehicles. The preferences may be derived from an online history associated with each of the vehicles. The weighted preference function may be derived from a relative ranking for the preferences associated with each of the vehicles. The relative ranking may be derived from one or more of a frequency of occurrence of the preferences in an online history, a time since a last search for the preferences, and an amount of time spent searching for the preferences. The controller may be further programmed to send an incentive associated with the advertisement to the vehicles that were within the maximum viewing distance during display of the advertisement. A contribution to the weighted preference function may increase responsive to a redemption frequency of incentives previously sent to a corresponding vehicle increasing. A contribution to the weighted preference function may increase responsive to a number of occupants of a corresponding vehicle increasing.

A method includes receiving, by a controller, preference and vehicle data from one or more vehicles within a predetermined distance of a roadside display. The method further includes causing, by the controller, the roadside display to display an advertisement corresponding to one of a plurality of preferences from the vehicles within a maximum viewing distance of the roadside display that maximizes a weighted preference function that weights the preferences by a viewing time for each of the vehicles.

The method may further include sending, by the controller, an incentive associated with the advertisement to the vehicles that were within the maximum viewing distance during display of the advertisement. The preference and vehicle data may include a plurality of customer preferences, a position, and a speed for each of the vehicles. The weighted preference function may further weight the preferences by a relative ranking for the preferences associated with each of the vehicles. The viewing time for each of the vehicles may be a ratio of a distance from the display of a corresponding vehicle to a speed of the corresponding vehicle. The method may further include receiving, by the controller, position and purchase history from the vehicles for a predetermined time after displaying the advertisement and evaluating an effectiveness of the advertisement based on one or more of the purchase history being indicative of a purchase of an advertised item and the position being indicative of a visit to an advertised location.

A vehicle includes a controller configured to communicate with a roadside display and one or more nomadic devices, and programmed to receive preference data from the mobile devices, and, responsive to a position of the vehicle being within a predetermined distance of the roadside display, transmit the preference data, the position, and a speed of the vehicle to the roadside display.

The vehicle may further include a display module and wherein the controller is further programmed to receive an incentive from the roadside display and cause the incentive to be displayed on the display module. The controller may be further configured to receive an incentive from the roadside display and cause the incentive to be displayed and retained in one or more of the nomadic devices. The vehicle may further include a wireless transceiver and the controller may be further programmed to directly communicate via the wireless transceiver with the roadside display. The vehicle may further include a cellular network transceiver and the controller may be further programmed to communicate via the cellular network transceiver with the roadside display.

### BRIEF DESCRIPTION OF THE DRAWINGS

FIG. 1 is a possible configuration of a vehicle communication system.

FIG. 2 is a first possible configuration of a roadside advertising system.

FIG. 3 is a second possible configuration of a roadside advertising system.

FIG. 4 is a flowchart for a possible set of operations for selecting an advertisement for display.

FIG. 5 is a flowchart for a possible set of operations for a vehicle-based computing system for interfacing with a roadside advertising system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

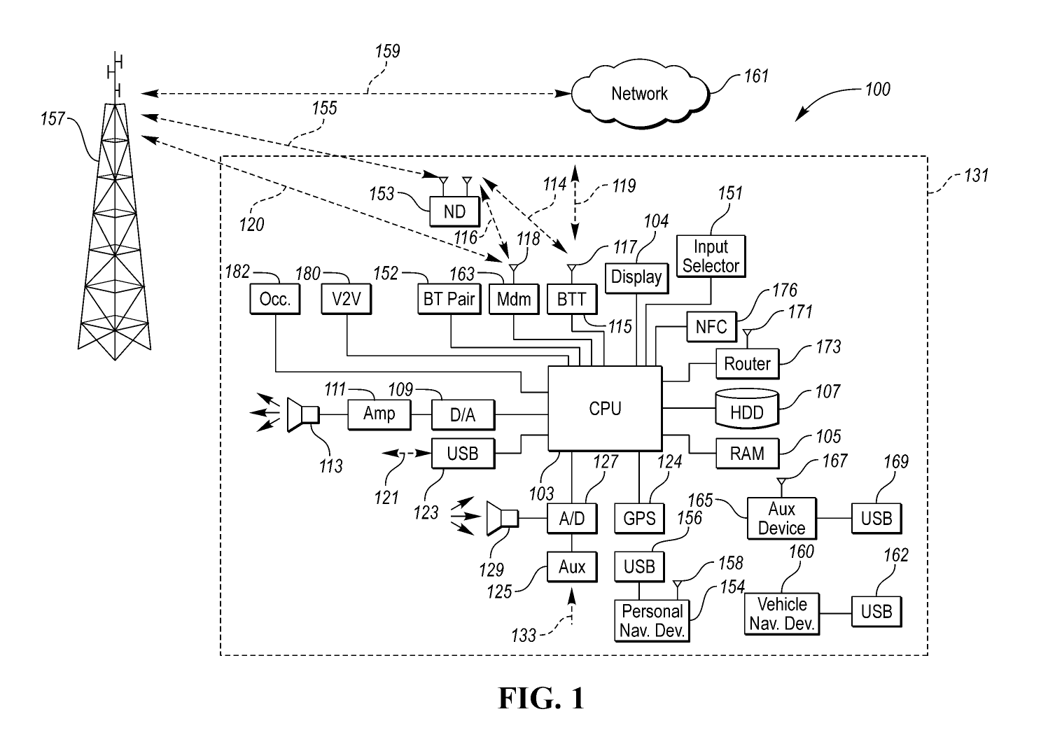

FIG. 1 illustrates an example block topology for a vehicle-based computing system 100 (VCS) for a vehicle 131. An example of such a vehicle-based computing system 100 is the SYNC system manufactured by THE FORD MOTOR COMPANY. The vehicle 131 enabled with the vehicle-based computing system 100 may contain a visual front-end interface 104 located in the vehicle 131. The user may be able to interact with the interface 104 if it is provided, for example, with a touch sensitive screen. In another illustrative embodiment, the interaction occurs through, button presses, spoken dialog system with automatic speech recognition and speech synthesis.

In the illustrative embodiment shown in FIG. 1, at least one vehicle processor 103 controls at least some portion of the operation of the vehicle-based computing system 100. Provided within the vehicle 131, the processor 103 allows onboard processing of commands and routines. Further, the vehicle processor is connected to both non-persistent 105 and persistent storage 107. In this illustrative embodiment, the non-persistent storage 105 is random access memory (RAM) and the persistent storage 107 is a hard disk drive (HDD) or flash memory. Non-transitory memory may include both persistent memory and RAM. In general, persistent storage 107 may include all forms of memory that maintain data when a computer or other device is powered down. These include, but are not limited to, HDDs, CDs, DVDs, magnetic tapes, solid state drives, portable USB drives and any other suitable form of persistent memory.

The vehicle processor 103 may also include several different inputs allowing the user and external systems to interface with the vehicle processor 103. The vehicle-based computing system 100 may include a microphone 129, an auxiliary input port 125 (for input 133), a Universal Serial Bus (USB) input 123, a Global Positioning System (GPS) input 124, a screen 104, which may be a touchscreen display, and a BLUETOOTH input 115. The VCS 100 may further include an input selector 151 that is configured to allow a user to swap between various inputs. Input from both the microphone 129 and the auxiliary connector 125 may be converted from analog to digital by an analog-to-digital (A/D) converter 127 before being passed to the vehicle processor 103. Although not shown, numerous of the vehicle components and auxiliary components in communication with the VCS may use a vehicle network (such as, but not limited to, a Controller Area Network (CAN) bus, a Local Interconnect Network (LIN) bus, a Media Oriented System Transport (MOST) bus, an Ethernet bus, or a FlexRay bus) to pass data to and from the VCS 100 (or components thereof).

Outputs from the vehicle processor 103 may include, but are not limited to, a visual display 104 and a speaker 113 or stereo system output. The speaker 113 may be connected to an amplifier 111 and receive its signal from the vehicle processor 103 through a digital-to-analog (D/A) converter 109. Outputs can also be made to a remote BLUETOOTH device such as a Personal Navigation Device (PND) 154 or a USB device such as vehicle navigation device 160 along the bi-directional data streams shown at 119 and 121 respectively.

In one illustrative embodiment, the system 100 uses the BLUETOOTH transceiver 115 with an antenna 117 to communicate with a user's nomadic device 153 (e.g., cell phone, smart phone, Personal Digital Assistance (PDA), or any other device having wireless remote network connectivity). The nomadic device 153 can then be used to communicate over a tower-network communication path 159 with a network 161 outside the vehicle 131 through, for example, a device-tower communication path 155 with a cellular tower 157. In some embodiments, tower 157 may be a wireless Ethernet or WiFi access point as defined by Institute of Electrical and Electronics Engineers (IEEE) 802.11 family of standards. Exemplary communication between the nomadic device 153 and the BLUETOOTH transceiver 115 is represented by Bluetooth signal path 114.

Pairing the nomadic device 153 and the BLUETOOTH transceiver 115 can be instructed through a button 152 or similar input. Accordingly, the CPU is instructed that the onboard BLUETOOTH transceiver 115 will be paired with a BLUETOOTH transceiver in a nomadic device 153.

Data may be communicated between the vehicle processor 103 and the network 161 utilizing, for example, a data-plan, data over voice, or Dual Tone Multi Frequency (DTMF) tones associated with nomadic device 153. Alternatively, it may be desirable to include an onboard modem 163 having antenna 118 in order to establish a vehicle-device communication path 116 for communicating data between the vehicle processor 103 and the network 161 over the voice band. The nomadic device 153 can then be used to communicate over the tower-network communication path 159 with a network 161 outside the vehicle 131 through, for example, device-tower communication path 155 with a cellular tower 157. In some embodiments, the modem 163 may establish a vehicle-tower communication path 120 directly with the tower 157 for communicating with network 161. As a non-limiting example, modem 163 may be a USB cellular modem and vehicle-tower communication path 120 may be cellular communication.

In one illustrative embodiment, the vehicle processor 103 is provided with an operating system including an application programming interface (API) to communicate with modem application software. The modem application software may access an embedded module or firmware on the BLUETOOTH transceiver 115 to complete wireless communication with a remote BLUETOOTH transceiver (such as that found in a nomadic device 153). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Other wireless communication means that can be used in this realm is free-space optical communication (such as IrDA) and non-standardized consumer IR protocols or inductive coupled means including but not limited to near-field communications systems such as RFID.

In another embodiment, nomadic device 153 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Division Multiple Access (CDMA), Time Division Multiple Access (TDMA), Space-Division Multiple Access (SDMA) for digital cellular communication, including but not limited to Orthogonal Frequency-Division Multiple Access (OFDMA) which may include time-domain statistical multiplexing. These are all International Telegraph Union (ITU) International Mobile Telecommunication (IMT) 2000 (3G) compliant standards and offer data rates up to 2 Mbps for stationary or walking users and 385 Kbps for users in a moving vehicle. 3G standards are now being replaced by IMT-Advanced (4G) which offers 100 Mbps for users in a vehicle and 1 Gbps for stationary users. If the user has a data-plan associated with the nomadic device 153, it is possible that the data-plan allows for broad-band transmission and the system could use a much wider bandwidth (speeding up data transfer). In still another embodiment, nomadic device 153 is replaced with a cellular communication device (not shown) that is installed to vehicle 131. In yet another embodiment, the nomadic device 153 may be a wireless local area network (LAN) device capable of communication over, for example (and without limitation), an IEEE 802.11g network (i.e., WiFi) or a WiMax network.

In one embodiment, incoming data can be passed through the nomadic device 153 via a data-over-voice or data-plan, through the onboard BLUETOOTH transceiver 115 and to the vehicle's internal processor 103. In the case of certain temporary data, for example, the data can be stored on the HDD or other storage media 107 until the data is no longer needed.

Additional sources that may interface with the vehicle 131 include a personal navigation device 154, having, for example, a USB connection 156 and/or an antenna 158, a vehicle navigation device 160 having a USB 162 or other connection, an onboard GPS device 124, or remote navigation system (not shown) having connectivity to network 161. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the vehicle processor 103 may be in communication with a variety of other auxiliary devices 165. The auxiliary devices 165 can be connected through a wireless (e.g., via auxiliary device antenna 167) or wired (e.g., auxiliary device USB 169) connection. Auxiliary devices 165 may include, but are not limited to, personal media players, wireless health devices, portable computers, and the like.

The vehicle processor 103 may be connected to one or more Near Field Communication (NFC) transceivers 176. The NFC transceivers 176 may be configured to establish communication with compatible devices that are in proximity to the NFC transceivers 176. The NFC communication protocol may be useful for identifying compatible nomadic devices that are proximate the NFC transceivers 176.

Also, or alternatively, the vehicle processor 103 may be connected to a vehicle-based wireless router 173, using for example a WiFi (IEEE 802.11) transceiver/antenna 171. This may allow the vehicle processor 103 to connect to remote networks in range of the local router 173. In some configurations, the router 173 and the modem 163 may be combined as an integrated unit. However, features to be described herein may be applicable to configurations in which the modules are separate or integrated.

The vehicle processor 103 may interface to a vehicle-to-vehicle (V2V) communication system 180 or transceiver. The V2V communication system 180 may be a Dedicated Short Range Communication (DSRC) system configured to transmit and receive messages directly between vehicles and infrastructure devices when within a predetermined range of one another. The V2V communication system 180 may implement established communication protocols.

The vehicle 131 may include one or more occupancy sensors 182 to identify a number of vehicle occupants. The occupancy sensors 182 may be in communication with the vehicle processor 103. In some configurations, the occupancy sensors 182 may be weight sensors that are positioned in some or all of the seating positions of the vehicle. When an amount of weight detected exceeds a predetermined threshold, the seating position may be identified as being occupied. In some configurations, the occupancy sensors 182 may include one or more cameras that are positioned to provide images of the seating positions. The vehicle processor 103 or other controller may process the images to identify occupied seating positions. The vehicle processor 103 may be programmed to identify a total number of vehicle occupants.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Most anyone who has been in a vehicle is familiar with billboards along the roadway. Billboards may be used to advertise any number of items and/or establishments. Traditional billboards have a message that is fixed for a period of time. The period of time is generally the amount of time between manual updates of the billboards. As technology has improved, traditional billboards are being displaced with electronic billboards. An electronic billboard can change the display contents at more frequent intervals. Further, the electronic billboard allows the display to cycle through a number of advertisements in a short period of time. While an improvement over fixed billboards, the electronic billboards cycle through a fixed list of advertisements. However, the advertisements are still displayed without regard to the interests or preferences of the vehicles passing by.

As vehicles are implemented with autonomous capability, passengers may have more time to perform other functions. For example, passengers may search the internet using nomadic devices. In addition, roadside advertising may pose less of a distraction as the autonomous vehicles require little operator intervention. Passengers may be able to focus on a roadside advertisement for a longer duration than previously. This presents opportunities for presenting more effective advertisements along the roadway.

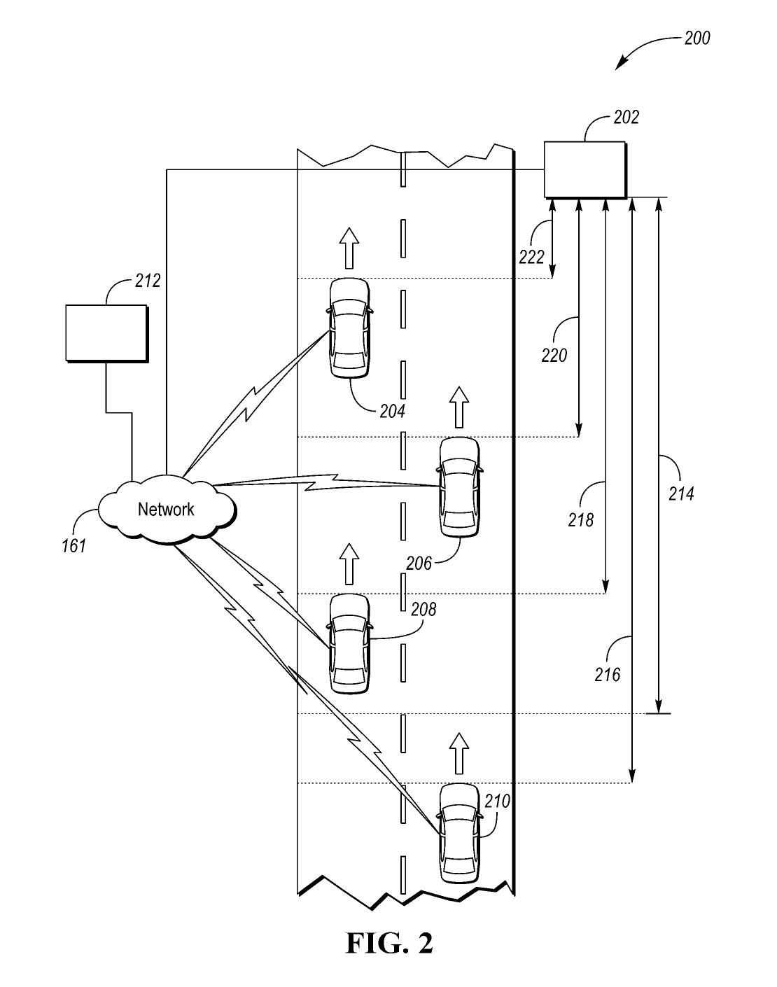

FIG. 2 depicts a roadside advertising system 200 in which vehicles may be configured with the vehicle-based computing system 100 as described herein. The vehicles may be autonomous vehicles configured to operate with minimal or no driver intervention. One or more vehicle occupants may pair a nomadic device 153 with the vehicle communication system 131 via a wired connection (e.g., USB) or wireless transceiver (e.g., BLUETOOTH). The nomadic device 153 may be configured to transfer predetermined data to the vehicle processor 103. For example, the nomadic device 153 may include a web browser or other program/application for retrieving data from a network (e.g., 161). For example, a nomadic device user may utilize the web browser to search the internet to retrieve information from various websites. The user may type in search terms and a list of related web sites and/or pages may be returned. The user may select one of the web sites/pages to visit. A feature of the web browser may be the retention of the browsing history of the device. For example, the nomadic device 153 may retain a history of search terms and web sites/pages viewed on the nomadic device 153. In addition, the nomadic device 153 may maintain a history of prior purchases made while using the nomadic device 153. For example, purchases completed while using the nomadic device 153 may be stored in a non-volatile memory for later retrieval. An online history for the user may include the search history, the browsing history and the purchase history of the user. The online history may be transferred to the vehicle processor 103 for processing and categorization. For example, the vehicle processor 103 and nomadic device 153 may transfer data through the BLUETOOTH transceiver 115.

In some configurations, the online history may be sent to a controller 212 that is connected to the network 161. The controller 212 may process the online history data and associate the online history data with the nomadic device owner. For example, the controller 212 may maintain a customer profile associated with a customer identifier and the online history data may be associated with the customer identifier. Processing the online history data may include categorizing the types of website/webpages that have been viewed by the device owner. The online history data may also be categorized according to search terms. The categories may include general interests such as sports or activities. The categories may include shopping interests and/or stores. In addition, the data may be organized within sub-categories within each category. For example, a broad category may be a food category or a sports category. There are numerous categories that may be defined. Additional categories may include television, music, investing, real estate, clothing, tools, and electronics/technology. The categories may represent online search preferences of the user and may be referred to as preferences.

The vehicle processor 103 may also be configured to retain a customer profile. The customer profile may include interests of the vehicle owner. The customer profile may be populated by the customer. For example, the customer may be directed to a web page that prompts the customer to answer a series of questions regarding hobbies and interests. The customer profile may be populated when the customer sets up an account to access the system. The customer profile may lead to additional preferences being identified for customer.

In return for sharing the profile and online history information with the system, the customer may be given incentives or coupons for related purchases. An advertisement for a restaurant may include a discount coupon to encourage a visit. Additional benefits may include gaming opportunities. For example, the roadside advertising system 200 may be used to participate in games for prizes. For example, the roadside advertising system may associate game tokens to particular advertisements. Customers may collect game tokens for prizes or other benefits. Such a system may provide some entertainment value for viewing the advertisements.

The roadside advertising system 200 may include at least one roadside advertising medium 202 that is located proximate a roadway. The roadside advertising medium 202 may be a large roadside display configured to dynamically change the display contents. The roadside advertising medium 202 may include a display comprised of clusters of light emitting diodes (LEDs). In other configurations, the roadside advertising medium 202 may include a liquid crystal display (LCD). The roadside advertising medium 202 may be configured to display a static advertisement image and/or a video advertisement. The roadside advertising medium 202 may be a stationary display such as an electronic billboard. The roadside advertising medium 202 may be a display on a building or other structure. The roadside advertising medium 202 may also be installed on a moving platform such as a bus or truck.

The roadside advertising system 200 may include a controller 212 that is configured to receive advertisements for display and output the advertisements to the display. The controller 212 may be configured to store and retrieve advertisements for display. The controller 212 may be coupled to the network 161. The network coupling may be a wired connection and/or a wireless connection. For example, the roadside advertising medium 202 may receive display content via the network 161. In some configurations, the controller 212 may be incorporated as part of the roadside advertising medium 202. In some configurations, the functions of the controller 212 may be divided among a computing system within the roadside advertising medium 202 and one or more servers coupled to the network 161.

A first vehicle 204 may be traveling on the roadway. The first vehicle 204 may be a first distance 222 from the roadside advertising medium 202 and moving at a first speed toward the roadside advertising medium 202. The first vehicle 204 may be in communication with the network 161. A second vehicle 206 may be traveling on the roadway. The second vehicle 206 may be a second distance 220 from the roadside advertising medium 202 and moving at a second speed toward the roadside advertising medium 202. The second vehicle 206 may be in communication with the network 161. A third vehicle 208 may be traveling on the roadway. The third vehicle 208 may be a third distance 218 from the roadside advertising medium 202 and moving at a third speed toward the roadside advertising medium 202. The third vehicle 208 may be in communication with the network 161. A fourth vehicle 210 may be traveling on the roadway. The fourth vehicle 210 may be a fourth distance 216 from the roadside advertising medium 202 and moving at a fourth speed toward the roadside advertising medium 202. The fourth vehicle 210 may be in communication with the network 161.

The roadside advertising medium 202 may be characterized by a maximum viewing distance 214. The maximum viewing distance 214 may be a distance beyond which the display cannot be viewed clearly by oncoming motorists. Occupants of vehicles located at distances less than the maximum viewing distance 214 may reasonably view the display.

Each of the vehicles may implement the vehicle-based computing system 100 as described herein. In some configurations, the vehicles and the roadside advertising medium 202 may communicate indirectly through the network 161. For example, the vehicles may be connected to the network 161 via a cellular link. The controller 212 that is connected to the network 161 may coordinate the display of advertisements based on vehicle data received from the vehicles. The vehicles may transfer position data (e.g., GPS data) and vehicle speed data to the controller 212. The roadside advertising medium 202 may be connected the network 161 via a wired or wireless network connection. The roadside advertising medium 202 may transfer GPS data and/or position data to the controller 212. In other configurations, the position of the roadside advertising medium 202 may be part of a database maintained by the controller 212. The vehicles may further transfer customer profile and online history information to the controller 212. In some configurations, the customer profile and online history information may be stored in the controller 212 and the vehicles may transfer a customer identification to the controller 212. The controller 212 may be in communication with a number of roadside advertising mediums 202 at different locations.

The total number of vehicle occupants may be transferred to the controller 212. The vehicle may periodically communicate the number of occupants of the corresponding vehicle over the network 161. While driving, the vehicles may periodically communicate the position and speed of the corresponding vehicle over the network 161 to the controller 212. The controller 212 may be programmed to monitor the position and speed data of the vehicles relative the roadside advertising medium 202. The controller 212 may be programmed to determine the first distance 222 between the first vehicle 204 and the roadside advertising medium 202. The controller 212 may determine the first distance 222 based on a GPS position of the first vehicle 204 and the position of the roadside advertising medium 202. In a similar manner, the controller 212 may be programmed to determine the second distance 220, the third distance 218, and the fourth distance 216.

The controller 212 may detect that multiple vehicles are in proximity to the roadside advertising medium 202. That is, multiple vehicles are within a predetermined distance of the roadside advertising medium 202. The predetermined distance may be greater than the maximum viewing distance 214. In response to detecting that a vehicle is within the predetermined distance, the controller 212 may request that the vehicle send preference data to the controller 212. In response to detecting that the vehicle is within the maximum viewing distance 214 of the roadside advertising medium 202, the controller 212 may utilize the preference and vehicle data for selecting an advertisement for display on the roadside advertising medium 202. The controller 212 may be programmed to select an advertisement for display based on the distances and the speeds of the vehicles and the preference data.

In some configurations, the controller 212 may transmit the location of an upcoming roadside advertising medium 202 to the vehicles. The vehicle processor 103 may be programmed to transmit vehicle and preference data over the network 161 in response to detecting that the vehicle is within the predetermined distance from the roadside advertising medium 202. For example, the vehicle processor 103 associated with the first vehicle 204 may be programmed to compute the first distance 222. In some configurations, the vehicles may include a navigation system in which a location of each roadside advertising medium is stored and retrieved based on a present vehicle position.

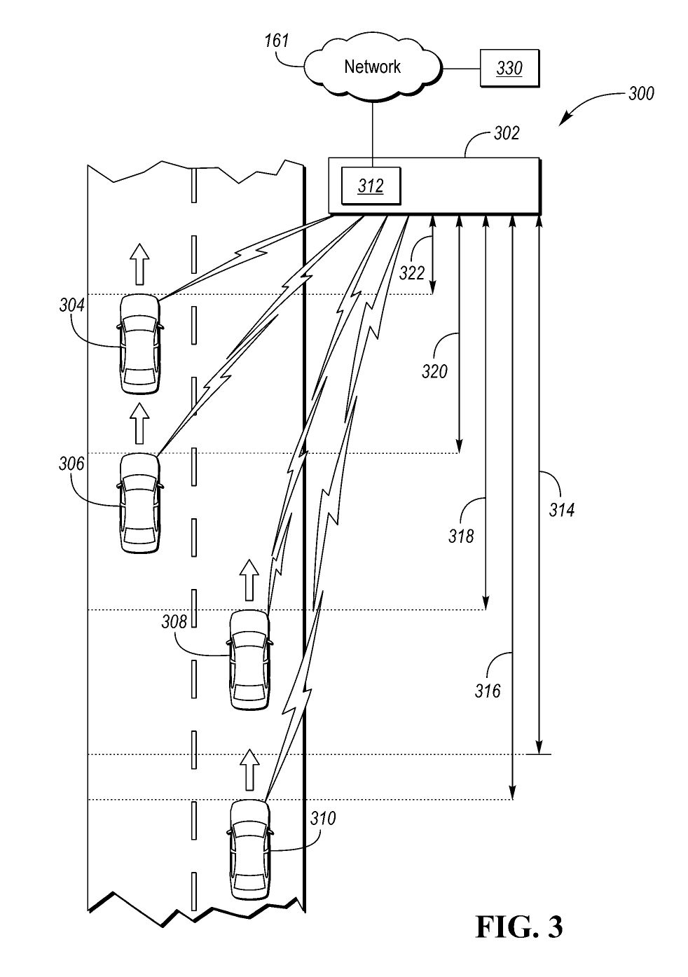

FIG. 3 depicts a roadside advertising system 300 in which the communication between the vehicles and a roadside advertising medium 302 is direct. The roadside advertising medium may be controlled by a controller 312. The controller 312 may be configured to communicate to an external server 330 over the network 161. In this configuration, the vehicles may establish communication directly with the controller 312 of the roadside advertising medium 302. For example, the roadside advertising medium 302 may include an antenna and a router configured to establish a wireless Ethernet network. Vehicles approaching the roadside advertising medium 302 may automatically establish a network connection and transfer vehicle and preference information to the controller 312. Vehicles may also transfer GPS data and vehicle speed data. The controller 312 may be programmed to process the vehicle and preference information to determine the best advertisement to be displayed. The roadside advertising medium 302 and the vehicles may communicate with one another via the V2V communication system.

A first vehicle 304 may be traveling on the roadway. The first vehicle 304 may be a first distance 322 from the roadside advertising medium 302 and moving at a first speed toward the roadside advertising medium 302. The first vehicle 304 may be in direct communication with the roadside advertising medium 302. A second vehicle 306 may be traveling on the roadway. The second vehicle 306 may be a second distance 320 from the roadside advertising medium 302 and moving at a second speed toward the roadside advertising medium 302. The second vehicle 306 may be in direct communication with the roadside advertising medium 302. A third vehicle 308 may be traveling on the roadway. The third vehicle 308 may be a third distance 318 from the roadside advertising medium 302 and moving at a third speed toward the roadside advertising medium 302. The third vehicle 308 may be in direct communication with the roadside advertising medium 302. A fourth vehicle 310 may be traveling on the roadway. The fourth vehicle 310 may be a fourth distance 316 from the roadside advertising medium 302 and moving at a fourth speed toward the roadside advertising medium 302. The fourth vehicle 310 may be in direct communication with the roadside advertising medium 302.

In some configurations, the vehicles may communicate with one another via the V2V communication system. The roadside advertising medium 302 may include a compatible V2V communication transceiver. In such a configuration, data may be transferred to the controller 312 by the vehicle that is the closest distance to the roadside advertising medium 302. Data may be transferred from vehicle to vehicle until the data ends up with the lead vehicle. The lead vehicle then transmits the data to the controller 312 when the vehicle is within a predetermined distance. Such a configuration allows the data to be collected prior to approaching the roadside advertising medium 302. In some configurations, the lead vehicle may pre-process the data for transmission to the controller 312. For example, the lead vehicle may determine the weighted preference function and selected a preference based on the weighted preference function.

The controller 312 may perform similar functions to the controller 212 of the roadside advertising system 200 depicted in FIG. 2. The controller 312 may retrieve advertisements via the network 161 and may transfer customer information via the network 161. The controller 312 may receive data from the external server 330 (e.g., advertisements for display) and may transmit data to the external server 330 (e.g., vehicle data for vehicles that pass by).

The selection of the advertisement may be similar in either of the configurations shown in FIG. 2 and FIG. 3. As an example, Table 1 depicts some example data for the vehicles. The data may be applicable to either FIG. 2 or FIG. 3. The first vehicle column provides data for the first vehicle 204 including the distance of the first vehicle 204 from the roadside advertising medium 202 and the speed of the first vehicle 204. Based on the speed and distance, a viewing time may be computed by the controller 212 or the vehicle processor 103. In addition, preferences from the online history and customer profile are listed. In this case, four preferences are listed. The system may be configured to maintain and store more entries than presented in this example. Similar data is depicted corresponding the second vehicle 206, the third vehicle 208, and the fourth vehicle 210.

TABLE 1

| | First | Second | Third | Fourth |
|---|---|---|---|---|
| | Vehicle | Vehicle | Vehicle | Vehicle |
| Distance (ft) | 150 | 200 | 340 | 400 |
| Speed (mph) | 60 | 70 | 65 | 62 |
| Viewing Time (s) | 1.7 | 1.95 | 3.57 | 4.4 |
| Preferences | Milk | Banking | Milk | TV |
| | Phones | Fast Food | Tools | Furniture |
| | TV | Diet | Fast Food | Milk |
| | Fast Food | Bicycles | Clothes | Phones |

The controller 212 may receive and process the preference data to determine a most effective advertisement for display. In some configurations, the controller 212 may parse the preference data and search for common preferences among the vehicles that are within the maximum viewing distance 214. In the example depicted in FIG. 2, the fourth vehicle 210 is beyond the maximum viewing distance 214 and the preference data of the fourth vehicle 210 may not be included in the selection. As depicted in Table 1, the preference of Fast Food appears in the preference data for each of the vehicles that are within the maximum viewing distance 214. In the case in which each vehicle includes a common preference, an advertisement may be selected that corresponds to the common preference. In this case, an advertisement related to Fast Food may be selected and displayed.

In some configurations, additional criteria may be used to select an advertisement. A weighted preference function may be used to select the advertisement. The weighted preference function may be derived from a viewing time for each of the vehicles that is a ratio of a distance of a corresponding vehicle from the display to a speed of the corresponding vehicle. The weighted preference function may be derived from a relative ranking for the preferences associated with each of the vehicles.

The position and speed of the vehicles may be used to determine a viewing time of the vehicle for an advertisement. For example, each vehicle will have a viewing time that depends on the position and speed of the vehicle. A vehicle traveling at a low speed at a large distance from the roadside advertising medium 202 may have a long viewing time. A vehicle traveling at high speed at a short distance from the roadside advertising medium 202 may have a short viewing time. The viewing time for each vehicle may be a ratio of the distance from the roadside advertising medium 202 to the speed of the vehicle.

The controller 212 may be programmed to compute a total viewing time for each of the preferences by summing each individual viewing time for each of the preferences. In some configurations, the preference having the largest total viewing time may be selected as the target preference. The controller 212 may search an advertisement database to find an advertisement related to the target preference. If more than one advertisement is compatible with the target preference, then additional selection criteria may be used. For example, advertisements may be selected according to a rotating schedule for each of the target preferences. Other criteria could include selecting advertisements that pay a higher fee for more prominent placement. In some configurations, the advertisement may be selected at random from those matching the target preference. If there are no advertisements that match the target preference, then the preference having the next highest total viewing time may be checked until a compatible advertisement is selected. In the example of Table 1, each vehicle includes the preference of Fast Food. The total viewing time may be computed as the sum of all of the viewing times which yields a maximum possible value for the vehicles that are within the maximum viewing distance 214. In this case, an advertisement related to Fast Food may be displayed.

The controller 212 may be programmed to compute a weighted preference function for each of preferences. The weighted preference function may be a function of the viewing time and the ranking of the preference for each of the vehicles. For example, the preferences for each of the vehicles may be numerically ranked with an integer value. The weighted preference function for a given preference may be the product of the numerical rank for the preference and the viewing time associated with the vehicle. For example, if four preferences are maintained, the highest ranked preference may be assigned a value of four. The lowest ranked preference may be assigned a value of one. The weighted preference function may be computed for each of the ranked preferences for each of the vehicles. Preferences may be ranked in a variety of ways. In some configurations, the preferences may be ranked by a frequency of occurrence of the preference in the online history data. More frequent occurrences of the preference in the online history may result in a higher ranking. In some configurations, the preferences may be ranked by a time since the last search related to the preference. Preferences appearing more recently in the online history may result in a higher ranking. In some configurations, the preferences may be ranked based on an amount of time spend searching for the preference. A customer that spends more time searching for a particular preference may be more interested in that preference and this may result in a higher ranking for the preference. The weighted preference functions may be summed across the vehicles for each of the preferences. Preferences that appear for multiple vehicles may result in a larger summed value so that an advertisement for that preference has a greater probability of being selected. Further, higher ranked preferences may have a greater probability of being selected.

In the example of Table 1, the preference of Milk would result in a weighted preference function value of 21.08. The preference of Fast Food would result in a weighted preference function of 14.69. In this example, the weighted preference function is maximized by the preference labeled as Milk In this case, an advertisement related to Milk may be selected and displayed. While the preference of Milk does not appear in the preferences for each vehicle, it is highly ranked in the vehicles for which it appears. The resulting advertisement that is displayed may be highly effective as the combined function of viewing time and interest level is maximized.

The weighted preference function may also include a multiplier based on the number of vehicle occupants. The contribution of the weighted preference function for each preference from a given vehicle may be multiplied by a factor based on the corresponding number of vehicle occupants. For example, preferences from a vehicle having more occupants should be given a higher weighting than a vehicle with fewer occupants. The multiplier may be increased as the number of vehicle occupants increases. In this manner, the weighted preference function can maximize the number of viewers of a given advertisement.

The weighted preference function may also include a factor based on how active a vehicle owner is in accepting benefits of the roadside advertising system. For example, the roadside advertising system 200 may provide various incentives that may result in economic benefits (e.g., coupons) and/or entertainment value (e.g., game tokens). Redemption of the incentives provided to a vehicle may be indicative of an active consumer of the roadside advertisement system 200. A multiplier may be based on the redemption frequency of the provided incentives. The contribution of the weighted preference function for each preference from a given vehicle may be multiplied by a factor based on the redemption frequency or history. Redemption may be tracked by the controller 212 responsive to receiving purchase history from the vehicles or data from participating businesses regarding purchases using the incentives. The multiplier may be increased as the redemption frequency increases. In the case of a gaming incentive, the multiplier may be based on the activity of the user related to the particular game (e.g., visiting a website to perform an action with the gaming token). The multiplier may be increased as the gaming activity increases. In this manner, the weighted preference function can bias the advertisement for active consumers of the advertisement. That is, the advertisements may be selected based on those users that are more likely to respond favorably to the advertisement.

The controller 212 may also determine a preferred display time based on the information. The controller 212 may also receive information from vehicles that are approaching the roadside advertising system but are not yet within the maximum viewing range. In addition, the controller 212 may predict when the vehicles which are presently in the viewing range will pass the roadside advertising medium 202. The controller 212 may process the information to determine subsequent advertisements. This information can also be used to extend the display time of a particular advertisement. For example, if the controller 212 determines that the next approaching vehicle also has a preference matching the presently displayed advertisement, the presently displayed advertisement may continue to be displayed. The controller 212 may compute the weighted preference function for a new set of vehicles taking into account the approaching and leaving vehicles.

In some configurations, there may be a minimum display time for an advertisement. The controller 212 may be programmed to ensure that an advertisement is displayed for a predetermined period of time.

In exchange for allowing access to the preference and vehicle information, drivers may be rewarded with coupons or other incentives. For example, vehicles in the viewing range whose data contributed to the selection of a displayed advertisement may receive a coupon or other incentive. The controller 212 may transmit an incentive to the vehicles that were within the maximum viewing distance while the advertisement was displayed. The incentive may be displayed on a display screen within the vehicle (e.g., display 104). The vehicle processor 103 may also be programmed to transmit the incentive to the nomadic device 153 for storage and display in the nomadic device 153. In the case of multiple vehicle occupants, the incentive may be transferred to multiple nomadic devices. In some configurations, incentives may be stored in the cloud and associated with a customer account. The customer may login into the customer account to view incentives.

The controller 212 may receive and monitor the preference and vehicle information over a period of time after displaying the advertisement to determine the effectiveness of the advertisement. In addition, the vehicles may maintain and transmit purchase history data to the controller 212. Further, the controller 212 may monitor the redemption of incentives to further evaluate the effectiveness. For example, a high redemption rate may be indicative of an effective advertisement. Further analysis of the preference data may indicate the most effective advertisements. For example, if a large number of vehicles pass with a particular preference, the display owner may try to market the location for advertisements related to the particular preference. In this case, it may be possible to charge a premium as it is known that potential customers are passing by that location. Monitoring the preference data may further indicate trends in customer preferences which may change over time. By continually monitoring the preference data, the system may better predict which advertisements may be effective.

Effectiveness of the advertisement may also be determined by receiving vehicle position information. If an advertisement is related to a business at a particular location, vehicle position data may be monitored to determine if the vehicle visited the business after viewing the advertisement. In addition, purchase information may be monitored to determine if an advertised product was purchased. The effectiveness of the advertisement may achieve a higher rating based on the purchase history being indicative of a purchase of an advertised item and/or the position data being indicative of a visit to an advertised location or establishment. Another measure of effectiveness may include a visit to a webpage promoted by the advertisement. The effectiveness of the advertisement may also be indicated by the redemption of incentives that are provided.

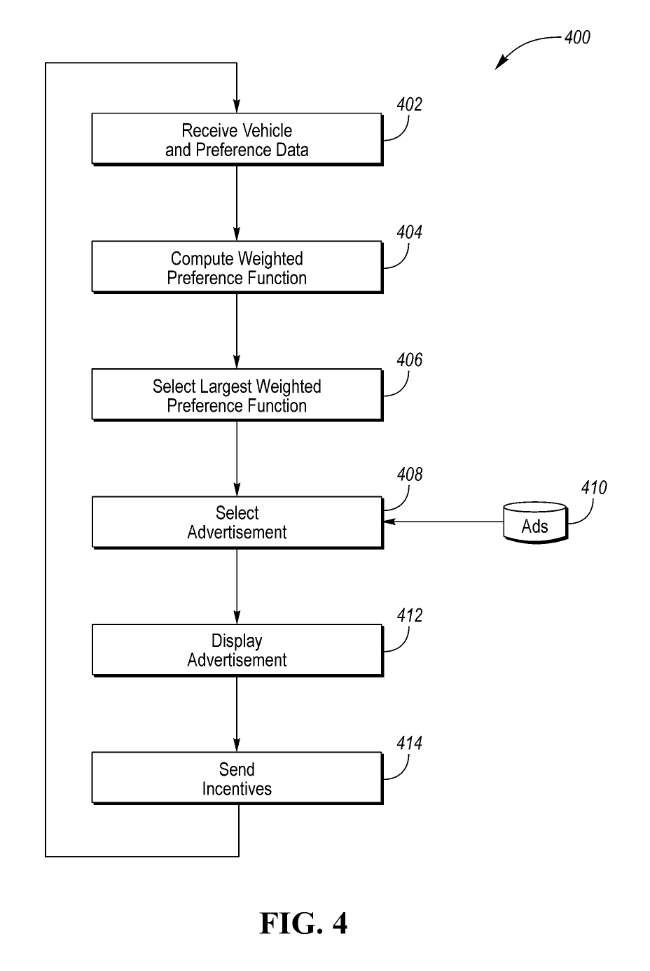

FIG. 4 depicts a possible flowchart 400 for a sequence of operations that may be programmed in the controller (e.g., 212, 312) for the roadside advertising system. At operation 402, the controller 212 may receive vehicle and preference data from the vehicles. The vehicle data may include position and speed of the vehicle.

At operation 404, the controller 212 may compute the weighted preference function as described herein. At operation 406, the controller 212 may compare the values of weighted preference function for each of the preferences and select the preference associated with the weighted preference function having the greatest value. At operation 408, the controller 212 may select an advertisement associated with the selected preference. Advertisements may be stored in an ad database 410. The ad database 410 may be maintained locally in the controller 212 and/or may be maintained by a central server connected to the network 161. The controller 212 may search the ad database 410 to find an advertisement related to the selected preference. At operation 412, the controller 212 may cause the roadside advertising medium 202 to display the advertisement. At operation 414, the controller 212 may send incentives the vehicles that were within the maximum viewing distance 214 while the advertisement was displayed. The operations may be repeated periodically.

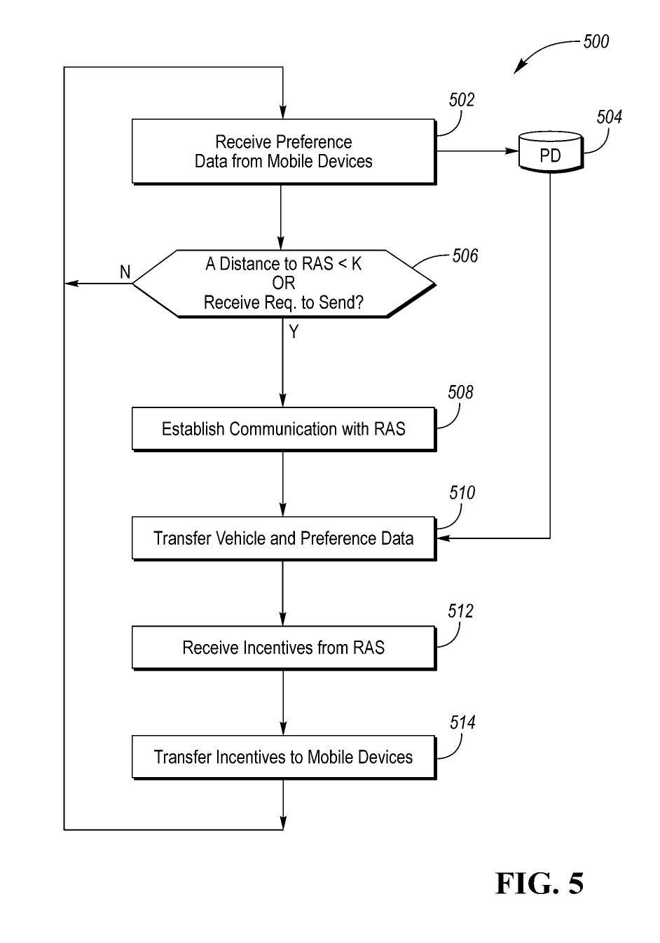

FIG. 5 depicts a possible flowchart 500 for a sequence of operation that may be programmed in a controller (e.g., vehicle processor 103) that resides in the vehicle. At operation 502, the vehicle processor 103 may receive preference data from nomadic devices (e.g., 153) that are paired or connected to the vehicle-based computing system. The preference data may be stored in a preference database 504 that interfaces with the vehicle processor 103 for later use. At operation 506, the vehicle processor 103 may check if preference data should be transmitted. Preference data may be transmitted if a distance to the roadside advertising system is less than a predetermined distance (e.g., K) or the vehicle processor 103 has received a request to send preference data by the roadside advertising system. If the transmit condition is not satisfied, operation 502 may be repeated. If the transmit condition is satisfied, operation 508 may be performed. At operation 508, the vehicle processor 103 may establish communication with the roadside advertising system. Communication may be established directly with the roadside advertising medium or indirectly over the network 161. At operation 510, the vehicle processor 103 may transfer the vehicle and preference data to the roadside advertising system. At operation 512, the vehicle processor 103 may receive incentives from the roadside advertising system. At operation 514, the vehicle processor 103 may transfer the incentives to the nomadic device 153. The vehicle processor 103 may also display the incentive on an in-vehicle display 104.

The roadside advertising system presented includes advantages over traditional roadside advertising. The system allows advertisements to be targeted to those vehicles that are within the viewing range. By selecting an advertisement that is related to preferences of the vehicle owner/occupants, the advertisement may be more effective and result in a purchase or visit. The system is also adaptive in that as preferences change, the advertisements are automatically adjusted to achieve the highest level of effectiveness. Further, customers receive some benefits for participating in the advertising system. Incentives can be provided that may reduce the cost of purchasing the advertised product. In addition, advertisements are displayed that are related to products or services in which the customer has an interest.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A roadside advertising system comprising:
a roadside display; and
a controller programmed to receive preference and vehicle data associated with one or more vehicles within a predetermined distance of the roadside display and to cause display of an advertisement corresponding to one of a plurality of preferences from the vehicles that maximizes a weighted preference function derived from vehicles within a maximum viewing distance of the roadside display.

2. The roadside advertising system of claim 1 wherein the weighted preference function is derived from a viewing time for each of the vehicles that is a ratio of a distance of a corresponding vehicle to the display to a speed of the corresponding vehicle.

3. The roadside advertising system of claim 1 wherein the preference and vehicle data includes at least some of the preferences, a position, and a speed for each of the vehicles.

4. The roadside advertising system of claim 1 wherein the preferences are derived from an online history associated with each of the vehicles.

5. The roadside advertising system of claim 1 wherein the weighted preference function is derived from a relative ranking for the preferences associated with each of the vehicles.

6. The roadside advertising system of claim 5 wherein the relative ranking is derived from one or more of a frequency of occurrence of the preferences in an online history, a time since a last search for the preferences, and an amount of time spent searching for the preferences.

7. The roadside advertising system of claim 1 wherein the controller is further programmed to send an incentive associated with the advertisement to the vehicles that were within the maximum viewing distance during display of the advertisement.

8. The roadside advertising system of claim 7 wherein a contribution to the weighted preference function increases responsive to a redemption frequency of incentives previously sent to a corresponding vehicle increasing.

9. The roadside advertising system of claim 1 wherein a contribution to the weighted preference function increases responsive to a number of occupants of a corresponding vehicle increasing.

10. A method comprising:
receiving, by a controller, preference and vehicle data from one or more vehicles within a predetermined distance of a roadside display; and
causing, by the controller, the roadside display to display an advertisement corresponding to one of a plurality of preferences from the vehicles within a maximum viewing distance of the roadside display that maximizes a weighted preference function that weights the preferences by a viewing time for each of the vehicles.

11. The method of claim 10 further comprising sending, by the controller, an incentive associated with the advertisement to the vehicles that were within the maximum viewing distance during display of the advertisement.

12. The method of claim 10 wherein preference and vehicle data includes a plurality of customer preferences, a position, and a speed for each of the vehicles.

13. The method of claim 10 wherein the weighted preference function further weights the preferences by a relative ranking for the preferences associated with each of the vehicles.

14. The method of claim 10 wherein the viewing time for each of the vehicles is a ratio of a distance from the display of a corresponding vehicle to a speed of the corresponding vehicle.

15. The method of claim 10 further comprising receiving, by the controller, position and purchase history from the vehicles for a predetermined time after displaying the advertisement and evaluating an effectiveness of the advertisement based on one or more of the purchase history being indicative of a purchase of an advertised item and the position being indicative of a visit to an advertised location.

16. A vehicle comprising:
a controller configured to communicate with a roadside display and one or more nomadic devices, and programmed to receive preference data from the nomadic devices, and, responsive to a position of the vehicle being within a predetermined distance of the roadside display, transmit the preference data, the position, and a speed of the vehicle to the roadside display.

17. The vehicle of claim 16 further comprising a display module and wherein the controller is further programmed to receive an incentive from the roadside display and cause the incentive to be displayed on the display module.

18. The vehicle of claim 16 wherein the controller is further configured to receive an incentive from the roadside display and cause the incentive to be displayed and retained in one or more of the nomadic devices.

19. The vehicle of claim 16 further comprising a wireless transceiver and wherein the controller is further programmed to directly communicate via the wireless transceiver with the roadside display.

20. The vehicle of claim 16 further comprising a cellular network transceiver and wherein the controller is further programmed to communicate via the cellular network transceiver with the roadside display.
